(19) United States
(12) Patent Application Publication
(10) Pub. No.: US 2014/0037357 A1
(43) Pub. Date: Feb. 6, 2014

(54) PRINT MEDIA GRIPPER ARRANGEMENT

(71) Applicants: Raimon Castelles, Sant Cugat Del Valles (ES); Oriol Moliner, Sant Cugat Del Valles (ES); Ignacio Picatoste, Sant Cugat Del Velles (ES); Daniel Gutierrez, Sant Cugat Del Valles (ES)

(72) Inventors: Raimon Castelles, Sant Cugat Del Valles (ES); Oriol Moliner, Sant Cugat Del Valles (ES); Ignacio Picatoste, Sant Cugat Del Velles (ES); Daniel Gutierrez, Sant Cugat Del Valles (ES)

(73) Assignee: HEWLETT-PACKARD DEVELOPMENT COMPANY, L.P., Houston, TX (US)

(21) Appl. No.: 14/110,855

(22) PCT Filed: Apr. 28, 2011
(86) PCT No.: PCT/US2011/034370

§ 371 Date: Oct. 9, 2013

(51) Int. Cl. B41F 21/04

(52) U.S. Cl. CPC B41F 21/04
USPC 400/617

(57) ABSTRACT

An example of a gripper arrangement is connected to a drive assembly, and arranged to guide print media along at least a portion of a print media path.

### BACKGROUND

Printers are usually equipped with a drive assembly for transporting print media along a print media path for printing.

### BRIEF DESCRIPTION OF THE DRAWINGS

For the purpose of illustration, certain examples of the present invention will now be described with reference to the accompanying drawings, in which:

FIG. 1 shows a diagram of an example of a printer in side view;

FIG. 2 shows a diagram of the example of the printer of FIG. 1 in top view;

FIG. 3 shows a diagram of another example of the printer of FIG. 1 in top view, including an example of a separate gripper arrangement drive;

FIG. 4 shows a diagram of yet another example of the printer of FIG. 1 in top view, including an example of a couple assembly;

FIG. 5 shows another example of a printer in side view;

FIG. 6 shows a detail of the example of the printer of FIG. 5 with an example of a gripper arrangement in perspective view;

FIG. 7 shows a detail of the example of the printer of FIG. 5 including a gap;

FIG. 8 shows another detail of the example of the printer of FIG. 5, including another gap;

FIG. 9 shows an example of a part of certain print media in top view;

FIG. 10 shows an example of a gripper arrangement in top view;

FIG. 11 shows another example of a gripper arrangement in top view;

FIG. 12 shows a detail of an example of a gripper arrangement in front view;

FIG. 13 shows an example of a printer in side view, similar to the example of FIG. 5, with examples of different operational positions of the gripper arrangement;

FIG. 14 shows a flow chart of an example of a method of threading print media through a printer; and

FIG. 15 shows a flow chart of another example of a method of threading print media through a printer.

### DETAILED DESCRIPTION

In the following detailed description, reference is made to the accompanying drawings. The examples in the description and drawings should be considered illustrative and are not to be considered as limiting to the specific example of element described. Multiple examples may be derived from the following description and/or drawings through modification, combination or variation of certain elements. Furthermore, it may be understood that also examples or elements that are not literally disclosed may be derived from the description and drawings by a person skilled in the art.

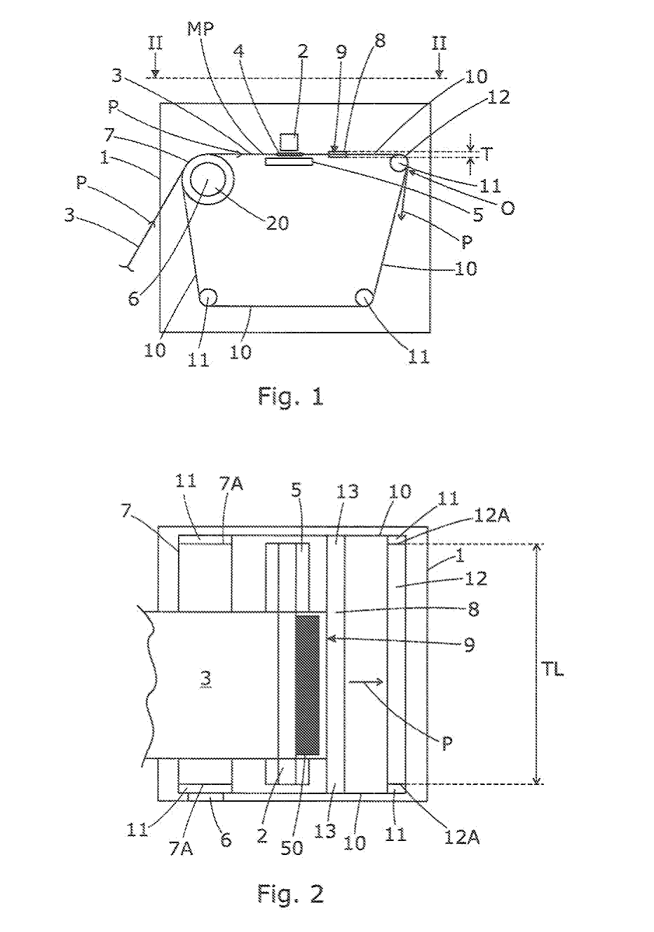

FIG. 1 shows an example of a printer 1. The example printer 1 includes a print head 2 for printing imaging material on print, media 3. The print head 2 is arranged to print onto the print media 3 in a print zone 4. In the drawing, the print zone $ is schematically indicated by a thick black line under the print head 2. In operation, the print media 3 is passed over the print zone 4 for printing. A print platen 5 may be provided under the print head 2, in the print zone 4. An example printer 1 includes an inkjet print head. Other example printers 1 include other types of print heads such as electrophotographic writers. The imaging material may include ink, toner or other imaging material.

The printer 1 is arranged to transport the media 3 along a media path, in a media feed direction P, as illustrated by arrows. The example printer 1 includes a drive assembly 6 for transporting the print media 3 along the media path for printing. For example, the drive assembly 6 drives a print media transport roller, such as a drive roller 7. The drive assembly 6 may include an electromotor and/or certain transmission elements such as gears and/or belts, for driving the drive roller 7.

The example printer 1 includes a gripper arrangement 8, arranged to grip the print media 3 near a leading edge 9 of the print media 3. The gripper arrangement 8 is arranged to guide the print media 3 along the media path, or at least along a portion MP of the media path. In FIG. 1, a portion of the media path MP extending along the print zone 4 is indicated. In an example, the gripper arrangement 8 is arranged to pull the print media in a straight feed direction P, at least as seen from a top view. The gripper arrangement 8 is connected to the drive assembly 6. In operation, the drive assembly 6 drives the gripper arrangement 8. The gripper arrangement 8 may have a relatively small thickness T for passing through relatively narrow gaps in the printer 1, through which the media 3 passes. The shown example gripper arrangement 8 is strip shaped for being able to pass relatively narrow gaps.

in an example, the gripper arrangement 8 is strip shaped and connected to a belt. For example, the gripper arrangement 8 comprises one or a combination of a bar, strip, sheet, film, flap, tube, etc. The gripper arrangement 8 may comprise two stiff strips for clamping the media 3, or one strip with a slot for the media 3. The gripper arrangement 8 may comprise any means for mechanical connection between the media 3 and the belt 10.

In an example, the printer 1 includes a belt 10 for transmitting a drive force to the gripper arrangement 8. The belt 10 is connected to the drive assembly 6. The belt 10 may be arranged to guide the gripper arrangement 8 along at least a portion of the media path MP. The belt 10 may be arranged to pull the print media in the feed direction P along at least a portion of the media path MP, in the shown example of FIG. 1, a media feed direction P may divert from the belt 10 where the media 3 is output, for example near a point O where the media 3 is taken off the printer 1 or connected to a media output arrangement. Here, the media 3 may be disconnected from the gripper arrangement 8.

The belt 10 may be connected to gears 11 and/or axles. In certain examples, the belt 10 is connected to media transport rollers 12, such as the drive roller 7. In further examples, the belt is connected to gears 11 that are connected to the ends of media transport rollers 7, 12. The belt 10 may be a continuous belt.

FIG. 2 represents an example top view of the printer 1 of FIG. 1, as indicated by line II-II in FIG. 1. The belt 10 may be arranged near both sides of the print zone 4 for pulling the print media 3 along a straight media path, in the feed direction P. In the shown example, each end 13 of the gripper arrangement 8 is connected to one of the belts 10. The belt 10 is connected to gears 11. The gears 11 may be connected to the respective ends 7A, 12A of the media transport rollers 12. At least one of the gears 11 may be connected, or connectable, to the drive assembly 6, for driving the belt 10 and the gripper arrangement 8.

In an example, the gripper arrangement 8 serves as a tool to place the print media 3 with respect to the print head 2 for printing. In a further example, the gripper arrangement 8 allows for printing to start close to the leading edge 9.

For example, printing may be started while the gripper arrangement 8 places the print media 3 with respect to the printer 1. FIG. 2 illustrates a printed image 50 on the print media 3 close to the leading edge 9 of the print media 3. For example, printing may be started approximately one to ten centimeters, or one to twenty centimeters, or one to thirty centimeters, or one to forty centimeters, or one to fifty centimeters, or several centimeters away from the leading edge 9.

As can be seen from the examples of FIG. 2, two belts 10 may be provided, one at each side of the print media path. The gripper arrangement 8 is arranged between, and connected to, the two belts 10. A total length TL of the gripper arrangement 8 may be at least a maximum print width for gripping a maximum size print media 3 along the media path.

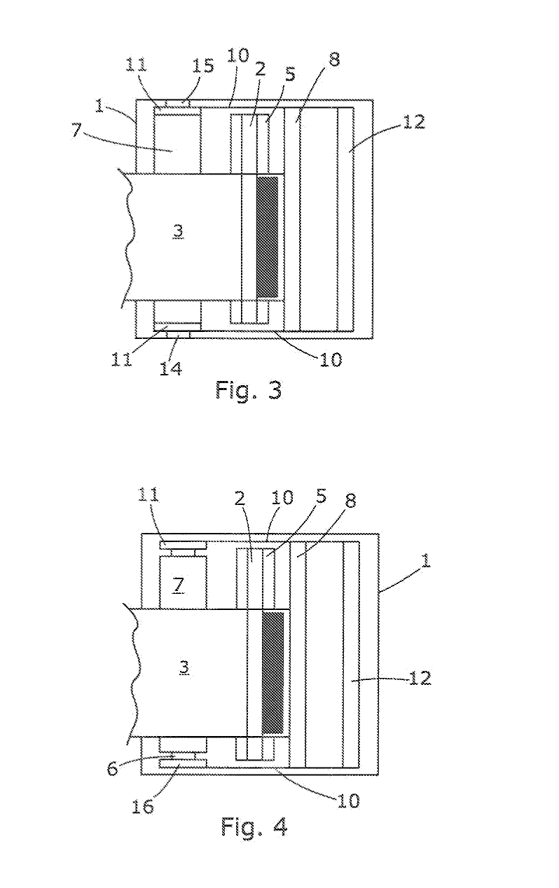

in an embodiment, the drive assembly 6 is arranged to activate and deactivate movement of the gripper arrangement 8 while the media transport rollers 7, 12 transport the media 3. Two examples of such drive assembly 6 are explained with reference to FIGS. 3 and 4.

in FIG. 3 another example of a top view of a printer 1 of FIG. 1 is shown, as indicated by line II-II in FIG. 1. Here, the drive assembly 6 includes a first drive 14 for the transport rollers 7, 12 and a second, separate drive 15 for the gripper arrangement 8. The second drive 15 may be connected to the belt 10 for driving the gripper arrangement 8. In an example the second drive 15 includes a servo control for activating and de-activating the second drive 15. The second drive 15 may include an electromotor and/or a transmission such as a gear or belt, in an example, the second drive 15 is arranged to drive the gripper arrangement 8 for guiding the print media 3. The second drive 15 may be arranged to be deactivated after the print media 3 is correctly positioned in the printer 1. The second drive 15 may be arranged to be activated after connecting the print media 3 with the gripper arrangement 8.

Rotational speeds of both first and second drive 14, 15 may be synchronized, for example through a printer controller 20, so that the rotational speed of respective media transport rollers 7, 12 and the speed of the gripper arrangement 8 correspond. In an example, the printer controller 20 is configured to signal the servo control for activating or de-activating the first drive 14 and/or the second drive 15. In a further example the second drive 15 is arranged to be activated and de-activated manually for example mechanically and/or through the printer controller 20. In another example the second drive 15 is arranged to be activated and de-activated automatically, for example through the printer controller 20.

In FIG. 4 yet another example of a top view of a printer 1 of FIG. 1 is shown, as indicated by line II-II in FIG. 1. Here, the drive assembly 6 includes a couple assembly 16 arranged to couple the gripper arrangement 8 to the drive assembly 6 and decouple the gripper arrangement 8 from the drive assembly 6. In an example, the drive assembly 6 drives the media transport rollers 7, 12, the gripper arrangement 8 is coupled to one of the media transport rollers 7, 12, and the couple assembly 16 is arranged to couple and decouple the gripper arrangement 8 with respect to the media transport rollers 7, 12. In another example, the couple assembly 16 is arranged to couple and decouple the belt 10 with respect to the drive assembly 6.

In an example, the couple assembly 16 is arranged to maintain a coupled condition of the gripper arrangement 8 for guiding the print media 3. In a further example, the couple assembly 1$ is arranged to decouple the gripper arrangement 8 after the print media 3 is correctly guided through the printer 1, in agar a further example, the couple assembly 16 is arranged to decouple the gripper arrangement 8 when the gripper arrangement 8 is in a parking position. A coupling and decoupling action may be mechanically triggered, manually and/or through a printer controller 20. The couple assembly 16 may be directly coupled to the drive assembly 6, or through one of the media transport rollers 7, 12 and/or through a transmission, gear 11, or belt or the like. In an example, the couple assembly 16 comprises a clutch.

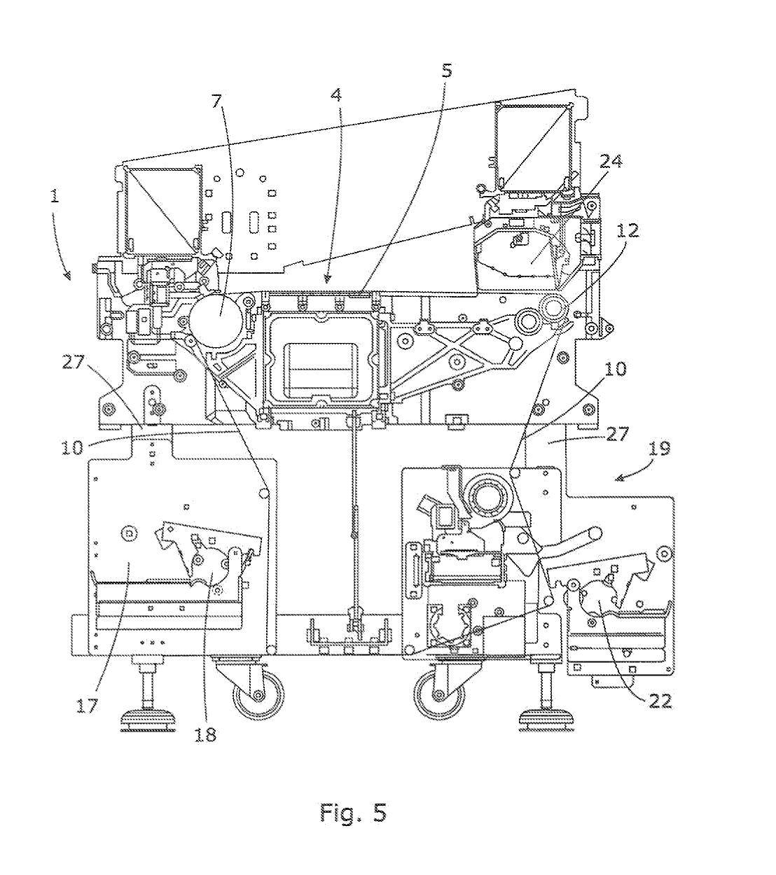

FIG. 5 illustrates another example of a printer 1 in cross sectional side view. The shown example may be a large format printer 1, having a print width of approximately 0.8 meter or more, for example up to approximately 6 meters wide. The shown example printer 1 includes a media input arrangement 17. The media input arrangement 17 may include a media roll support 18 for unwinding a media roll. The example printer 1 includes a drive roller 7, a print zone 4 and a print platen 5. The example printer 1 may includes at least one media transport roll 12 that may function as a diverter for the printed media 3. The example printer 1 includes a media output arrangement 19. In a further example, the media output arrangement 19 includes a media output roll support 22 for receiving, supporting and winding printed media 3 in a roll. The media output roll support 22 may include, or may be arranged to, support an output roll spindle. In certain examples, the media output arrangement 19 may be arranged to output printed media 3 letting the media 3 free fall out of the printer 1. For example, the media output arrangement 19 may include a tray or the like for receiving and supporting a free fall printed media 3, in addition to, or instead of a media output roll support 22. The example printer 1 further comprises a basic frame 27.

A printed image post processing module 24 may be provided between the print zone 4 and the media output arrangement 19. The printed image post processing module 24 may comprise a radiation source. The radiation source may comprise a heater and/or ultraviolet and/or infrared radiation source. The radiation source may be arranged to aid in curing and/or drying printed imaging material such as ink.

The shown example printer 1 comprises a belt 10 that is arranged substantially along the media path. The belt 10 comprises a continuous belt 10, in an example, the belt 10 comprises a chain of interlinking modules. For example, the gripper arrangement 8 is connected to at least one of these modules. In an example, the belt 10 is connected to the drive assembly 6 through multiple gears 11, arranged to guide the gripper arrangement 8 along the media path.

in an example, the belt 10 extends along the drive roll 7 for guiding the media 3 over the drive roll 7, in a further example, the belt 10 extends along the print zone 4 for guiding the media 3 over the print zone 4. In a further example, the belt extends along a printed image post processing module 24 for guiding the media 3 along the printed image post processing module 24. For example the media is guided along a UV radiation source and/or a heating source. In a further example, the belt extends along one or more media transport rollers 12 for guiding the media over the one or more media transport rollers 12. In a further example, the belt 10 extends along the media output arrangement 19 for guiding the media 3 to the media output arrangement 19. In again a further example, the belt 10 extends between the media input arrangement 17 and the media output arrangement 19 for guiding the gripper arrangement 8 from the media input arrangement 17 to the media output arrangement 19, therewith closing a continuous belt path in the printer 1.

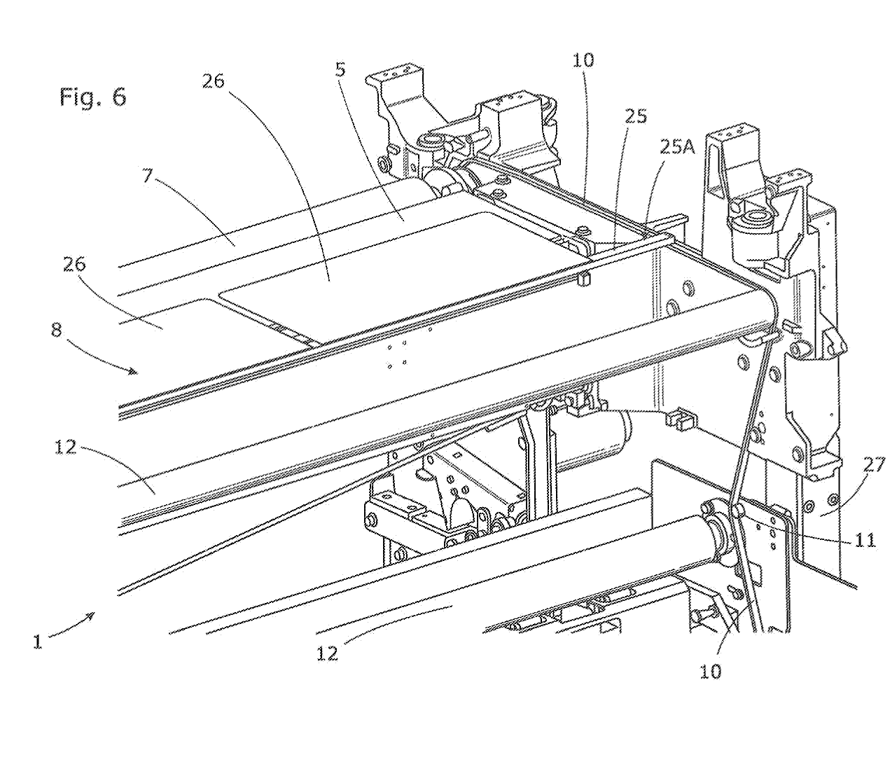

FIG. 6 shows a detail of an example of a printer 1. An example gripper arrangement 8 is provided. The example gripper arrangement 8 comprises a bar 25 that is connected to the belts 10 at its respective ends 25A. For example, the bar 25 comprise stiff material such as metal, stiff plastics and/or wood. The stiffness of the bar 25 may be such that it substantially does not deform when the gripper arrangement 8 pulls media 3 through the printer 1 for placing the media 3.

in an example, the gripper arrangement 8 is relatively flat so that, when the media 3 threads through the printer 1 it may pass through relatively narrow gaps in the printer 1. Connected to the bar 25 are pairs of sheets 26 or flaps. The pairs of sheets 26 are arranged to engage a top and a bottom surface of the print media 3. In an example the sheets 26 comprise magnetic elements for clamping the media between the sheets 26. The sheets 26 may comprise relatively flexible material with a high tensile strength. For example, the flexibility of the sheets 26 is such that the material bends together with the media 3 when curving around one of the media transport rollers 7, 12. The sheets 26 and/or magnetic elements are flat so as to pass through the gaps in the printer 1.

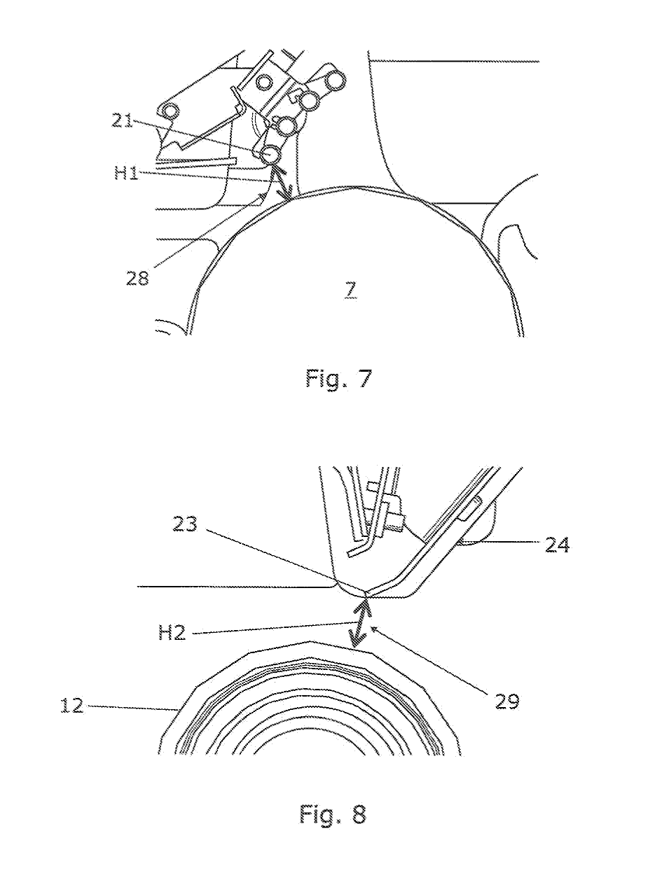

FIGS. 7 and 8 show the printer gaps 28, 29, respectively, through which media 3 passes during use. For example, a first gap 28, as shown in FIG. 7, is defined close to the drive roll 7. In the shown example, the first gap 28 is formed by the distance between the drive roll 7 and a first opposite printer part 21. For example, the first opposite printer part 21 comprises at least one pinch roll in a retracted position. In the shown example, the height H1 of the first gap 28, as formed by the distance between the drive roil 7 and the first opposite printer part 21, is approximately 13 millimeters.

A second gap, as shown in FIG. 8, may be provided near a media transport roller 12. In the shown example, the media transport roller 12 is provided opposite to the printed image post processing module 24. A part 23 of the post processing module 24 extends at a close distance from the respective media transport roller 12. The height H2 of the second gap 29 is defined by this distance. In an example, the height H2 of the second gap 29 is approximately 9.4 millimeters.

Different examples of printers 1 may comprise different gap heights H1, H2. In an example, the thickness T of the gripper arrangement 8 is smaller than the smallest gap height H1, H2 in the media path of the respective printer 1. In an example, the thickness T of the gripper arrangement 8 is approximately 2 centimeters or less, or approximately 1 centimeter or less, or approximately 0.9 centimeters or less. The thickness T of the gripper arrangement 8 may be determined by the thickness of the bar 25 and/or by the thickness of the sheets 26 and magnetic elements.

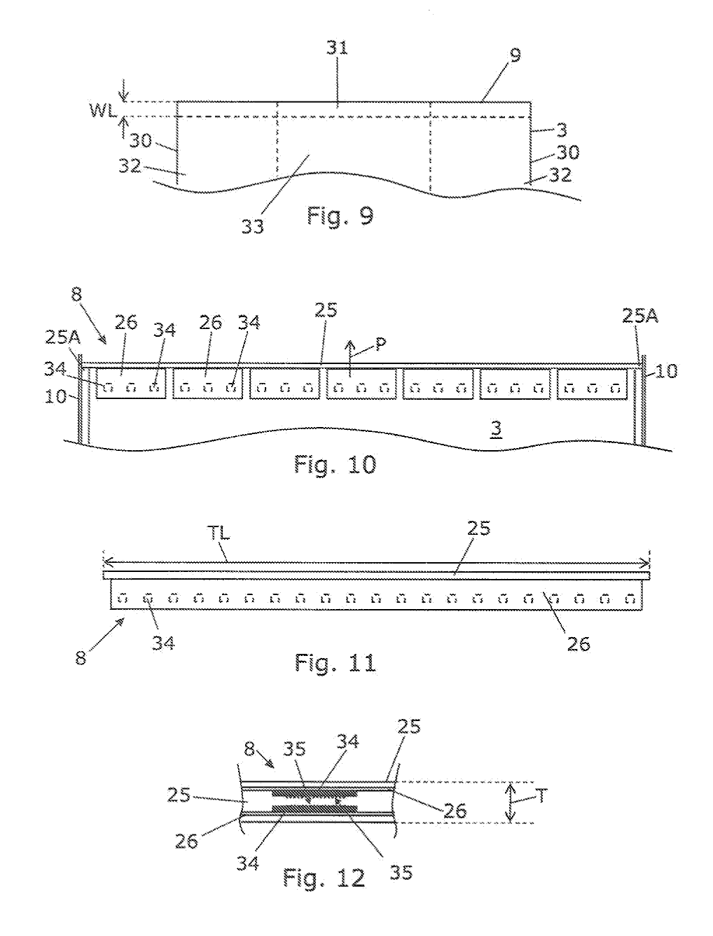

FIG. 9 shows an example of print media 3. The print media 3 has a leading edge 9, which represents the front edge of the media 3 when the media 3 is transported in the media path. The shown example of media 3 comprises a leading portion 31 close to the leading edge 9. For example, the leading portion 31 has a length WL of approximately 50 centimeters or less, or 40 centimeters or less, or 20 centimeters or less, or 10 centimeters or less. In an example, the media 3 is gripped by the gripper arrangement 8 in the leading portion 31, dose to the leading edge 9, for example by magnetic elements. The media 3 comprises side edges 30. The media 3 comprises side portions 32 close to the side edges 30. For example, in use pinch wheels may engage the side portions 32 of the media 3. The media 3 may comprises a middle portion 33 that extends between the side portions 32, in the middle of the media 3. For example, the middle portion 33 covers 50% of the width of the media 3 and the side portions 32 each cover 25% of the width of the media 3. As can be seen, parts of the middle portion 33 and the side portions 32 overlap with the leading portion 31.

The gripper arrangement 8 may provide for a balanced grip on the media 3 along its leading edge 9. As can be seen from the examples of FIG. 10, the gripper arrangement 8 is arranged to engage the media 3 in the middle portion 33 and in the side portions 32 of the leading portion 31 of the print media, so that the media 3 can be guided and/or pulled through the printer 1 while preventing skew and/or deformation.

In FIG. 10 an embodiment of a gripper arrangement 8 with multiple pairs of sheets 26 or flaps is shown. The sheets 26 are connected to the bar 25. The bar 25 is connected to the belt 10 at its ends 25A. The sheets 26 are provided with at least one magnetic element 34 for clamping the print media 3. For example, at least three magnetic elements 34 are connected to one sheet 26. The opposite sheets 26 of each pair of sheets 26 are provided with opposite elements 34 that magnetically attract.

in FIG. 11 another example of a gripper arrangement 8 is shown where only one pair of sheets 26 is connected to the bar 25. The respective sheets 26 are arranged substantially along the print zone width for pulling the media 3. For example, the sheets 26 are connected to at least approximately 75% of the total length TL of the has 25. The sheets 26 comprise multiple magnetic elements 34, for example more than three magnetic elements, more than five magnetic elements, or more than ten magnetic elements 34.

In an example, the material of the sheets 26 has on the one hand a high tensile strength, and on the other hand is flexible, so as to withstand relatively high pulling forces while being able to curve around the respective rollers 7, 12, respectively. For example, the sheet material comprises a polymer material such as PET film, nylon film, etc. For example a tensile strength of the sheet material may be at least approximately 100 MPA, or at least approximately 150 MPA, or at least approximately 180 MPA. However, the tensile strength may vary for example depending on the chosen thickness of the sheets 26.

FIG. 12 shows a pair of sheets 26, wherein each sheet 26 is provided with a magnetic element 34. For example, one of the sheets 26 comprises magnetic elements 34 and the opposite sheet comprises a metallic element that attracts and/or is attracted by the opposite magnetic element 34. In another example, the opposite sheets 26 are both provided with magnetic elements 34 that have opposite poles. For example, the magnetic elements 34 comprise permanent magnets. In a further example, the media engaging surface of at least one of the magnetic element 34 and/or magnetically attracting element has a surface 35 with a relatively high friction with respect to the print media 3. The may prevent slipping of the media 3 with respect to the gripper arrangement 8. For example, a relief may be arranged in, or provided on top of, the surface 35 of the respective element 34. For example, the surface 35 of the respective element 34 may comprise elastomeric material that provides for said friction.

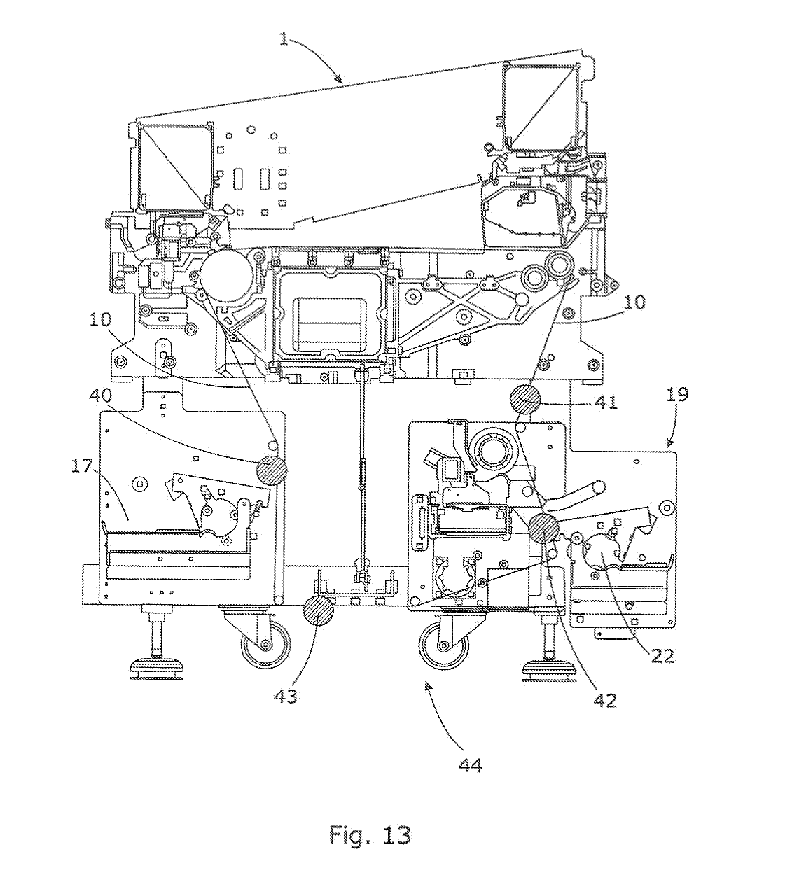

FIG. 13 shows an example of a printer 1, wherein different example positions of the gripper arrangement 8 are indicated. The shown example printer 1 comprises a continuous belt 10 that runs through the printer 1 in the media feed direction P. Before transporting the media 3 through the printer, the gripper arrangement 8 may be positioned in a media input position 40. In the media input position 40 the gripper arrangement 8 is positioned upstream of the print zone 4, for example nearby the media input arrangement 17 for gripping print media 3 that is positioned in the media input arrangement 17. In a further example, the gripper arrangement 8 is positioned for gripping the leading edge 9 of a print media roll that is supported in the input media roll support 18.

In a media release position, the gripper arrangement 8 is positioned downstream of the print zone 4, for example near the media output arrangement 19 for releasing the media 3 from the gripper arrangement 8, for example for connecting the media 3 with a respective media output arrangement 19. In the shown example, there are two media release positions 41, 42 of the gripper arrangement 8. A first media release position 41 may comprise a roll-to-free fall position of the gripper arrangement 8, at which the media 3 can be released so that the media 3 free falls. A second media release position 42 may comprise a roll-to-roll position of the gripper arrangement 8, at which the media can be released to readily connect the media 3 to the media output roll support 22.

In a further example, the gripper arrangement 8 may be positioned in a parking position 43. For example, the parking position 43 may be arranged between the media release position 41, 42 and the media input position 40, for example near a bottom of the printer 1. In operation, the gripper arrangement 8 and/or belt 10 may be deactivated hi the parking position 43, for example through use of a coupling assembly 16 or a second drive 15, while printing may continue.

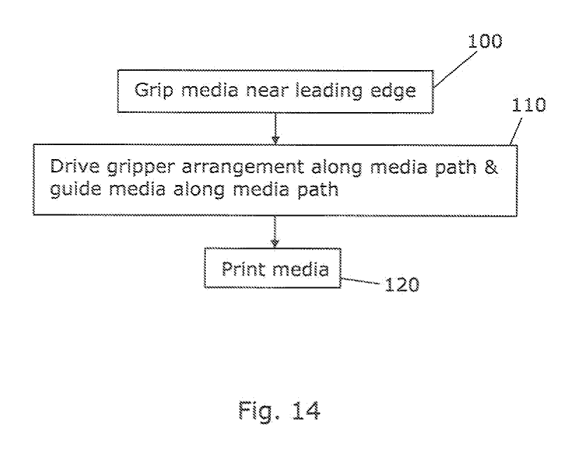

FIG. 14 shows a flow chart of an example of a method of threading print media 3 through the printer 1. The example method includes gripping the print media 3 near its leading edge 9 with the gripper arrangement 8 (block 100). The example method further includes driving the gripper arrangement 8 along at least a portion of the media path and therewith guiding the print media 3 along least a portion of the media path (block 110). The example method further includes printing the print media 3 (block 120) in the media path, for example while it is being guided through the print zone 4 by the gripper arrangement 8.

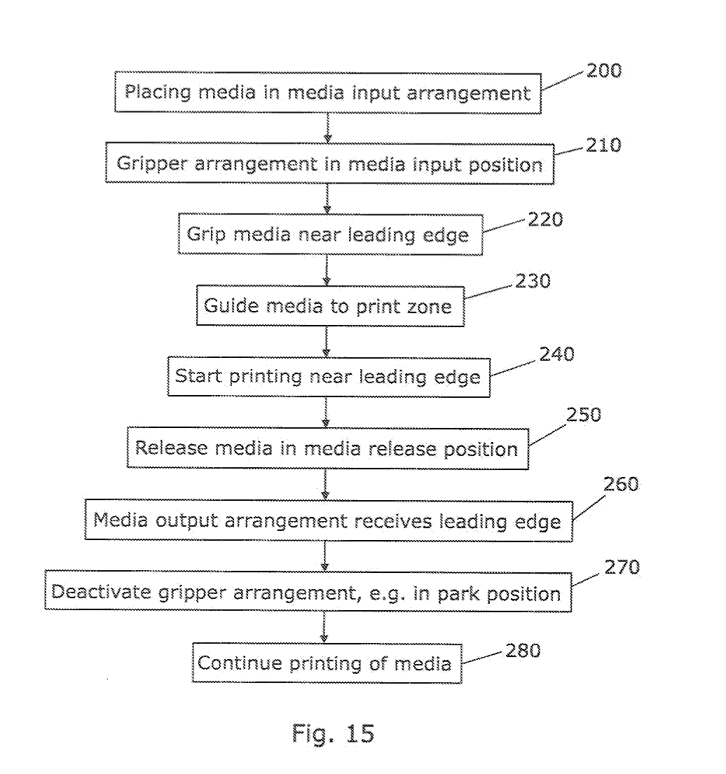

FIG. 15 shows a flow chart of a further example of a method of threading print media 3 through the printer 1. The example method may include placing the media 3 in the media input arrangement 17 of the printer 1 (block 200). The media 3 may comprise a media roll. The example method includes placing the gripper arrangement 8 in the media input position 40 (block 210). The gripper arrangement 8 may be placed in the media input position 40 by the drive assembly 6, for example with the aid of a belt 10 and a couple assembly 16 and/or a second drive 15. The gripper arrangement 8 may be activated to be placed into said media input position 48 manually and/or automatically, for example with a mechanical and/or electrical switch. An example of an electrical switch is connected to the printer controller 20.

The example method includes gripping the print media 3 near its leading edge 9 (block 220), by the gripper arrangement 8. For example, the gripper arrangement 8 engages a leading portion 31 of the print media 3. For example, the print media 3 is gripped along its width, or at least in a middle portion 33 and a side portion 32. This may prevent, skew and/or deformation of the print media 3. In a further example the gripper arrangement 8 grips the leading edge 9 of the media roil for making a first print of the print media 3. In another example, the media 3 may be placed manually in the gripper arrangement 8 without first placing it in a media input arrangement 17.

The example method includes pulling the print media 3 to the print zone 4 (block 230) for printing. In a further example, some aspects of this disclosure allow for a suitable front and/or back tension to be achieved in the print media 3 while loading the print media 3, for example by using the gripper arrangement 8. An example method may allow printing to start near the leading edge 9 of the print media 3 (block 240). For example, the printer 1 may start printing after the gripper arrangement 8 has passed under the print head 2. Starting printing near the leading edge 8 of the media 3 may prevent waste of media 3.

The example method includes releasing the media 3 in the media release position 41, 42 (block 250). The released media 3 may be received by the media output arrangement 19 (block 260). For example, the media may be connected to a media output roller 22 for roll-to-roll printing, or may be allowed to free fall. After having released the media 8, the gripper arrangement 8 may be driven to the parked position by the drive assembly 6.

The example method may further include deactivating the gripper arrangement 8 (block 270). In an example, deactivating the gripper arrangement 8 may comprise decoupling the gripper arrangement 8 from the drive assembly 6. In another example, deactivating the gripper arrangement. 8 may include deactivating a second drive 15 that drives the gripper arrangement 8. In these examples, it should be understood that deactivating the gripper arrangement 8 may comprise deactivating the belt 10. In a further example, the gripper arrangement 8 is deactivated in the parked position.

In an example, after having released the print media 3, and/or having received the print media 3 by the media output arrangement 19, printing of the print media 3 is continued (block 280). For example, the gripper arrangement 8 may be used for placing the print media 3 in the printer 1 after which printing continues by transporting the media 3 without the gripper arrangement 8. With the gripper arrangement 8, printing can start during placement of the print media 3, while the gripper arrangement 8 pulls the media 3 through the printer 1. In an example, printing may temporarily be stopped when releasing the media 3 from the gripping arrangement 8 and connecting it to the media output roller 22 for roll-to-roll printing, and resumed after haying connected the leading edge 9 to the media output roller 22.

In one example, the gripper arrangement 8 is used to guide the media 3 through the printer 1, in an example, the gripper arrangement 8 is used to maintain a correct position of the print media 3 along the media path, while the media transport rollers 7, 12 move the print media 3 through the printer, in another example, the media transport rolls are not actively driven but can be freely rotated around their respective axes. In such example the gripper arrangement 8 may be used to pull the media 3 over the rolls 7, 12.

For example, a quality of a printed image may be influenced by a tension of the prim media in the media path. Guiding a print media 3 with the gripper arrangement 8 may in certain examples aid in maintaining a suitable tension in the print media 3. For example, the quality of a printed image may also be influenced by media advance movements. Guiding a print media 3 with the gripper arrangement 8 may in certain examples aid in controlling media is advance movements in the print media 3. Furthermore, the quality of a printed image may for example be affected when print, media skews, is wrinkled or deforms in the media path, or deviates from the media path. Guiding a print media 3 with the gripper arrangement 8 may in further examples prevent one or more of a media skew, wrinkling, deformation and a deviation.

The above description is not intended to be exhaustive or to limit this disclosure to the examples disclosed. Other variations to the disclosed examples can be understood and effected by those skilled in the art from a study of the drawings, the disclosure, and the appended claims. The indefinite article “a” or “an” does not exclude a plurality, while a reference to a certain number of elements does not exclude the possibility of having more or less elements. A single unit may fulfil the functions of several items recited in the disclosure, and vice versa several items may fulfil the function of one unit. Multiple alternatives, equivalents, variations and combinations may be made without departing from the scope of this disclosure.

1. Printer, comprising
a drive assembly for transporting print media along a media path for printing, and
a gripper arrangement, arranged to grip print media near a leading edge, connected to the drive assembly, for guiding the print media along at least a portion of the media path.

2. Printer according to claim 1, comprising a belt for connecting the gripper arrangement to the drive assembly for moving the gripper arrangement along at least a portion of the media path.

3. Printer according to claim 2, wherein the belt is arranged near both sides of a print zone.

4. Printer according to claim 1, comprising print media transport rollers, arranged to transport media along the media path, and connected to the drive assembly.

5. Printer according to claim 1, comprising a media output arrangement for receiving printed print media, wherein the drive assembly is arranged to deactivate gripper arrangement movement when the print media is received by the media output arrangement.

6. Printer according to claim 5, wherein the drive assembly comprises a drive for print media transport rollers and at least one of a separate drive for the gripper arrangement, and
a couple assembly for coupling and decoupling the gripper arrangement from the drive for the print media transport rollers.

7. Printer according to claim 1, the gripper arrangement having a height of approximately 2 centimeters or less.

8. Printer according to claim 1, wherein the gripper arrangement is arranged to engage at least a middle portion and a side portion of a leading portion of the print media.

9. Printer according to claim 1, wherein the gripper arrangement is strip shaped.

10. Printer according to claim 1, wherein the gripper arrangement comprises at least one magnetic element for clamping the media between the sheets by magnetic force.

11. Printer according to claim 1, the gripper arrangement comprising
a bar,
sheets connected to the bar, for engaging a top and a bottom surface of the print media, and
magnetic elements connected to the sheets for clamping the media between the sheets by magnetic force.

12. Method of threading print media, comprising
gripping a print media near its leading edge with a gripper arrangement,
driving the gripper arrangement along at least a portion of a media path, and
therewith guiding the print media along the media path for printing.

13. Method according to claim 12, comprising
starting printing close to the leading edge of the print media.

14. Method according to claim 12, comprising
gripping the print media in a media input position, wherein the gripper arrangement is positioned upstream of a print zone,
releasing the print media in a media release position, wherein the gripper arrangement is positioned downstream of the print zone,
parking the gripper arrangement, and
deactivating gripper arrangement movement.

15. Printer, comprising a drive assembly and a gripper arrangement connected to the drive assembly, the gripper arrangement being arranged to pull print media along at least a portion of a print media path.
